(19) United States
(12) Patent Application Publication
(10) Pub. No.: US 2018/0359405 A1
(43) Pub. Date: Dec. 13, 2018

(54) FRAME SYNCHRONIZATION OF MULTIPLE IMAGE CAPTURE DEVICES

(71) Applicant: SYMBOL TECHNOLOGIES, LLC, Lincolnshire, IL (US)

(72) Inventors: Richard Mark Clayton, Manorville, NY (US); Patrick Martin Brown, North Medford, NY (US); Chinmay Nanda, Port Jefferson Station, NY (US)

(21) Appl. No.: 15/620,532

(22) Filed: Jun. 12, 2017

(51) Int. Cl. H04N 5/232; H04N 5/247; H04N 7/18

(52) U.S. Cl. CPC H04N 5/23203; H04N 7/181; H04N 5/247

(57) ABSTRACT

A method and apparatus for synchronizing image frame capture timing for a plurality of fixed-frame rate image sensors having the same frame rate is disclosed. An example includes a processing system connected to image sensors in a venue for capturing image frames and determining a capture offset for each image sensor, against a common, independent time base. The processing system determines when the capture offset of any of the image sensors is above a threshold offset value and, in response, a restart signal is sent to the image sensor to restart the image sensor for capturing images within the venue at another capture offset. The process will continue for that image sensor until the image sensor has a capture offset within below an acceptable threshold value.

### BACKGROUND

When multiple data capture devices are utilized to obtain information, timing relationships between different instances of data capture are useful when analyzing the captured data. For example, when multiple image capture devices (also referred to herein as image sensors) are deployed in an environment to capture frames of image data representative of the environment, processing of the image data (e.g., to detect and/or measure objects located in the environment) benefits from and/or requires accurate indicators of the timing relationships between the frames of image data.

### BRIEF DESCRIPTION OF THE SEVERAL VIEWS OF THE DRAWINGS

FIG. 1 is a timing diagram illustrating an example jitter delay scenario for a two-image sensor system.

FIG. 2 depicts an example environment including multiple image sensors and an example frame synchronizer constructed in accordance with teachings of this disclosure.

FIG. 3 is a block diagram representative of an example implementation of the example frame capture synchronizer of FIG. 2, capable of executing example operations described herein in FIGS. 4-6.

FIG. 4 is a flowchart representative of an example process that may be executed by the example frame capture synchronizer of FIGS. 2 and/or 3 to synchronize capture of, for example, frames of image data by the image sensors deployed in the environment of FIG. 2.

FIG. 5 is a flowchart representative of an example process that may be executed by the example frame capture synchronizer of FIGS. 2 and/or 3 to determine image sensor capture offset, as may be performed according to the example process of FIG. 4.

FIG. 6 is timing diagram illustrating image data frames from an image sensor determined to have a failed a offset threshold value by the example process of FIG. 4.

### DETAILED DESCRIPTION

While the following description is presented in the context of an environment including image capture devices (also referred to as image sensors) configured to capture image data representative of the environment, example methods and apparatus to synchronize data capture disclosed herein are applicable to any data capture system. Further, the image sensors described herein are example data capture devices and example methods and apparatus disclosed herein are applicable to any suitable type of data capture device(s).

In the context of image sensors, an individual instance of image data corresponding to one time is referred to as a frame and, thus, synchronization of image capture operations may be referred to as frame capture synchronization.

When multiple data capture devices are utilized simultaneously, synchronization of data capture across the data capture devices is often beneficial and/or required. For example, when capturing a scene including motion using multiple image sensors (e.g., three-dimensional (3D) sensors, video cameras, etc.), it is desirable to synchronize the capture of image data across the plurality of image sensors. For instance, knowing that the different frames captured by the different image sensors truly correspond to the same time (e.g., the same millisecond) enables accurate merging of the image data from the different frames to form an aggregate image of a scene. For example, image capture and analysis are used within retail, wholesale, and warehouse venues to track and record movement of targets of interest, such as inventory and personnel. Additionally, different types of sensors may be positioned throughout a venue and configured to detect a target, such as a radio frequency identification (RFID) transponder located on an object of interest (e.g., a shipping container, such as a box) in the venue. In some instances, these sensors determine the location of the target, as well as properties of a product of interest (e.g., an item contained with the shipping container) associated with the target. The information obtained from these sensors may be used to trigger and control an image capture system that obtains and records image data representative of the object associated with the target. The image capture system may be configured to obtain and record the image data in response to additional or alternative prompts or triggers (e.g., the target entering a designated area or user instructions to image the designated area).

Recorded image data may be used by various systems. Dimensioning systems, for example, use captured image data representative of the object to determine, for example, dimensions of the object. One type of image capture device used in dimensioning systems is a depth imaging sensor, which captures three-dimensional (3D) data representative of the environment. Such depth imaging sensors may be implemented as, for example, 3D cameras (e.g., RGB-D image sensors) capable of applying a 2D matrix to depth measurements. The three-dimensional data can be used to determine dimension(s) of the object, thereby provided data representative of the shape of the object. When determining the dimension(s) of the object, different perspectives of the object are useful to obtain information regarding different surfaces and/or edges of the object. As such, different frames of image data (which each correspond to a particular time) from the differently located depth imaging sensors are merged together to provide a full view of the object. For the merging of the different frames to accurately represent the object, the frames need to truly correspond to a single time, especially when motion is occurring in the scene.

As discussed further below, depth imaging sensors can capture image data at a high frame rate (e.g., 30 frames per second (fps) or faster). These depth imaging sensors are examples of fixed frame rate image capture devices. For example, a venue may have many image sensors, depending on the size of the venue. In the examples disclosed herein, each image sensor has the same image capture frame rate, and each image sensor has a fixed frame rate that does not change during operation. These fixed frame rate image sensors may be implemented by, for example, 3D cameras, 3D video cameras, RGB-D sensors, and/or any other suitable fixed frame rate image capture devices.

In operation, frames of image data representative of the same scene within a venue are captured from numerous image sensors and analyzed together (e.g., by a dimensioning application). For example, an RFID transponder may be sensed within a venue and a dimensioning system may instruct one or more image sensors to perform image capture and/or depth measurements on an area associated with the sensed RFID transponder. In other examples, a light-based distance measurement may be used to trigger the dimensioning system to capture images and perform depth measurements. Multiple frames of depth measurements may then be merged together to arrive at a complete set of depth measurements for the object from different perspectives. By using sufficiently high frame rates, the relative movement of the object within the venue may be properly captured in a fluid manner.

The relative positions and angles of the image sensors is either known or discovered so that the captured image data can be merged together. When the scene being imaged does not include movement (e.g., the object being dimensioned is stationary), there are no changes from one frame to the next and, thus, frames from the multiple image sensors can be used without synchronization (e.g., knowledge that each of the frames correspond to the same time). Furthermore, when the scene being imaged does not include movement, frames of image data can be averaged to reduce noise since there is no frame to frame movement.

On the other hand, when the scene includes movement, an object moving within a venue can be captured and dimensioned if a sufficient number of frames are captured from different image sensors and if the image sensors have fast enough frame rates. For example, at ten (10) miles per hour (mph) an object travels roughly fifteen (15) feet in one second. Using an image sensor with a frame rate of thirty (30) frames per second (fps), then object will move six (6) inches from one frame to the next.

Unfortunately, many image sensors do not allow for control or synchronization of the frame capture times between multiple image sensors. As such, without frame capture synchronization, frames from different image sensors will have different capture times, within a 30th of a second period. With the object moving six (6) inches in a 30th of a second, the position of the object captured by any two image sensors varies by zero (0) to six (6) inches depending on the relative difference in capture times. This speed dependent change in object position from one image sensor to another means that captured data cannot be merged together simply by knowing the relative positions and angles for the image sensors.

Even with fixed frame rate image capture devices, substantial variability (e.g., jitter) in a frame timestamp and in the timing of the receipt of that frame at a host device (e.g., a centralized server or workstation executing a dimensioning application) can vary. For example, driver and system load considerations may introduce a variability in a timestamp associated with a frame and an actual time of a delivery of that frame to the host device. Put another way, even though the hardware of the different image capture devices is configured to capture frames at the same fixed frame rate, varying latency in timestamping the frames and delivery of the frames to the host device makes successfully merging the frames based on timestamps difficult, if not impossible. For example, a dimensioning application attempting to merge frames from two image sensors might look at frame capture timestamps to find a case where the timestamps have the smallest difference at the millisecond level. The assumption being that frames with close timestamps were captured closer together in time than frames with slightly less close timestamps. Examples disclosed herein recognize that this assumption is wrong. The true relative capture times for two fixed frame rate sensors remain constant. However, the jitter in timestamps only makes them appear to the dimensioning application as more or less corresponding to the same time. That is, despite the consistency in the frame capture rate between the image sensors, the dimensioning application (or other type of application operating on the received image data) has a distorted (i.e., inaccurate) view of the timing relationship between the frame due to the variability in latency of reporting the image data and the associated timestamps to the dimensioning application. Accordingly, there are drawbacks and disadvantages to relying on timestamp image data to process the image sensors, especially when motion in the scene is present.

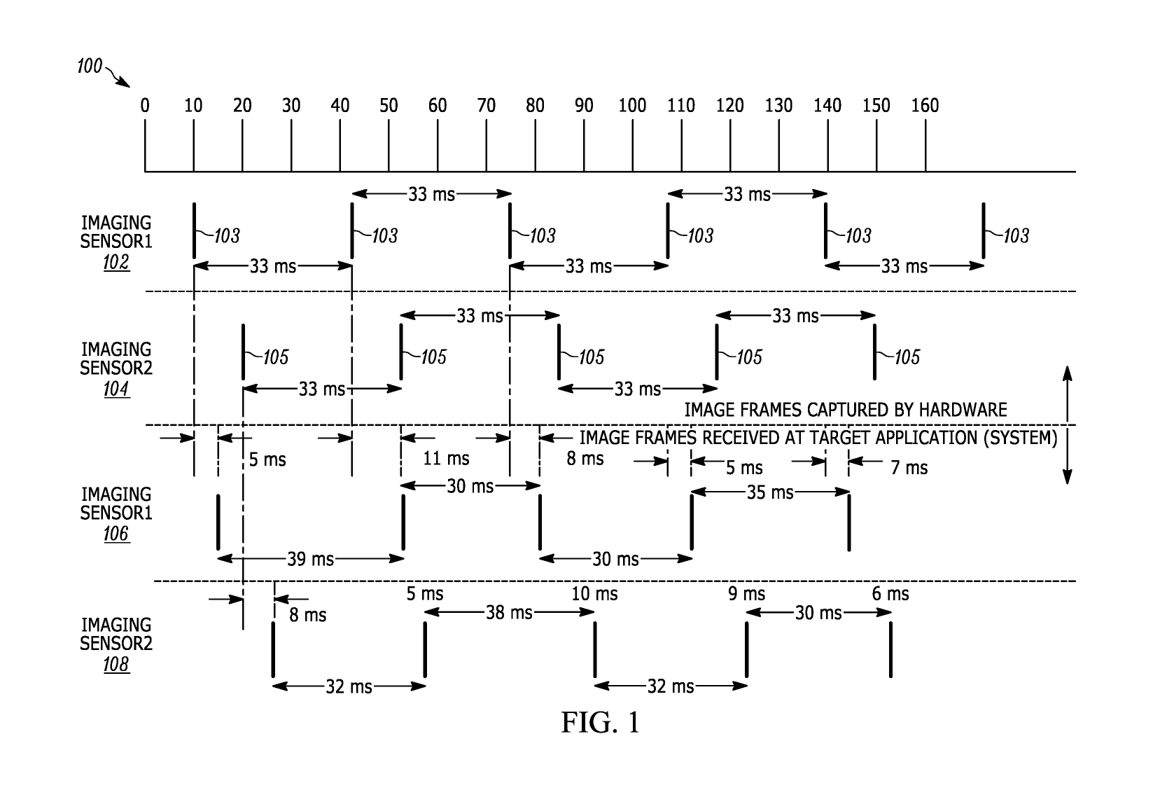

FIG. 1 is timing diagram 100 illustrating an example jitter delay scenario for a conventional two-image sensor system. Timing diagram 102 for a first image sensor referred to as Imaging Sensor1 illustrates that the hardware of the Imaging Sensor1 captures image data 103 at a fixed frame rate or 30 fps, corresponding to a 33 ms delay between each image data capture (i.e., frame capture). Timing diagram 104 for a second image sensor referred to as Imaging Sensor2 illustrates that Imaging Sensor2 also has a hardware that captures image data 105 at a fixed frame rate of 30 fps, corresponding to a 33 ms delay between each image data capture. As common in imaging systems without synchronized clocks, Imaging Sensor1 and Imaging Sensor2 capture images at different times, in the illustrated example 12 ms apart from one another.

Timing diagrams 106 and 108, respectively, illustrate the problem that results from jitter and other timing delays. While in the illustrated example Imaging Sensor1 and Imaging Sensor2 collect image data in a consistent manner (i.e., at a fixed frame rate), the timing of the receipt of that image data at a target application (e.g., a dimensioning application executed on a processing platform) can vary greatly. The variation may result from jitter in the image sensor itself. The variation may result from the signal communications or a network. The variation may result from fluctuating operation, e.g., jitter, at the processing platform. As shown in the example timing diagram 106, the result for the Imaging Sensor1 is that different frames of the image data 103 are received at the processing platform at differently spaced apart intervals. Initially, for a first frame, there is a 5 ms delay from when the corresponding image data was captured (and timestamped) at the Imaging Sensor1 and when that frame is received. But, instead of that 5 ms delay persisting each time a frame of the image data 103 is received, the next frame of image data from the Imaging Sensor1 is received 39 ms later, reflecting a 11 ms delay from when the corresponding frame of image data was captured. With varying timing differences between receipt of image data, the timing diagram 106 shows different capture offsets of 5 ms, 11 ms, 8 ms, 5 ms, and 7 ms, from when the data was captured at the Imaging Sensor1. Likewise, as shown in the timing diagram 508, the Imaging Sensor2 exhibits offsets of 8 ms, 5 ms, 10 ms, 9 ms, and 6 ms. These offset values are determined from the given time an image was captured and are provided for illustration purposes. These offsets show the latency in delivering and time-stamping frame data at the processing platform.

Also, illustrated in the timing diagram of FIG. 1, are the timing variances between receipt of corresponding frames across the Imaging Sensor1 and Imaging Sensor2. Each imaging sensor may be positioned in a system to capture an image of the same scene, target, or object, but from a different angle. The timing variances between corresponding image data from the sensors varies, 12 ms, 6 ms, 14 ms, 16 ms, and 11 ms, with 6 ms as the smallest difference and 16 the largest difference.

Examples disclosed herein address the issues demonstrated by the timing diagram of FIG. 1. In particular, and as described in detail below, methods and systems disclosed herein provide synchronized data capture timing for, for example, multiple data capture devices, such as multiple image sensors deployed in an image-based dimensioning system. In examples disclosed herein, the images sensors have a fixed-frame rate and each of the image sensors has the same frame rate or a harmonic of that frame rate. In examples, the frame rate is thirty (30) frames per second (fps), with sixty (60) fps as a first harmonic. An example frame capture synchronizer (e.g., implemented by a logic circuit) disclosed herein is in communication with the image sensors and is configured to determine a capture offset for each of the image sensors relative to a common time base (e.g., a central time source). Notably, the capture offset of individual image sensors determined by examples disclosed herein is relative to a common time base (e.g., an external clock) rather than relative to other ones of the image sensors. As described in detail below, utilization of the common time base avoids by examples disclosed herein eliminates or at least reduces the uncertainties associated with the jitter/latency problem illustrated above in connection with FIG. 1.

The example frame capture synchronizer disclosed herein determines when the capture offset of any of the image sensors is above a offset threshold value. If the capture offset for a particular image sensor is determined to above the offset threshold value, a restart signal is sent to that image sensor. In some instances, one or more frames of image data associated with time(s) at which the capture offset falls outside the offset threshold value may be discarded (e.g., not provided to and/or considered by a dimensioning application). The restart signal causes that image sensor to restart image data capture operations at a different capture offset relative to the common time base. The example frame capture synchronizer disclosed herein continues to restart that image sensor, as well as for any other image sensor falling outside the offset threshold value, until the capture offset for the image sensor is determined be within an acceptable range. That is, the example frame capture synchronizer disclosed herein re-evaluates the new, different capture offset of the image sensor and, if the image sensor is again found to violate the offset threshold value, conveys another restart signal to the corresponding image sensor.

The example frame capture synchronizer disclosed herein repeats this process until the image sensor is determined to be within the offset threshold value. In response to the image sensor having a capture offset that meets the offset threshold vale, the example frame capture synchronizer disclosed herein accepts (e.g., does not discard) images captured by the image sensor.

Techniques disclosed herein may be used in connection with, for example, image sensors for which the underlying hardware capture frame rate is constant for the image sensors. With the techniques disclosed herein, frames of image data can be delivered to a target application, such as a dimensioning application, as the images become available while ensuring that proper, sufficient timing agreement is achieved among the image sensors. In this way, jitter, which invariably affects timestamps and typically in random ways, may be removed from concern and the target applications in a system may accurately use a combination of image data frames captured by different image sensors. In some examples, the frame capture synchronizer is configured to process image frames before they are accessed by the target application, to ensure that the target application only accesses properly synchronized image frames. The frame capture synchronizer, for example, may pre-process received image frames at a logic circuit and then instruct the logic circuit to store only synchronized image frames to be accessed by a target application. The imaging stations and imaging sensors described herein may operate continually or periodically over an assigned time or in response to an external trigger, as described in various examples herein. For example, a triggering system communicatively coupled to imaging stations may be implemented as a triggering system that uses Light Detection and Ranging (LIDAR) to sense when a beam is broken (e.g., by a forklift), thus indicating that imaging stations should be activated for image capture. In other examples, the triggering system may be an image-based system, such as a camera identifying a forklift entering an area for freight dimensioning. Another example triggering system is one that uses barcode readers that read and detect when a barcode is present within freight carried on a forklift. If a barcode is detected and the forklift is in a proper location and distance, freight dimensioning may be performed on the items carried by the forklift. Of course, triggering and subsequent image capture may be implanted for applications other than freight dimensioning.

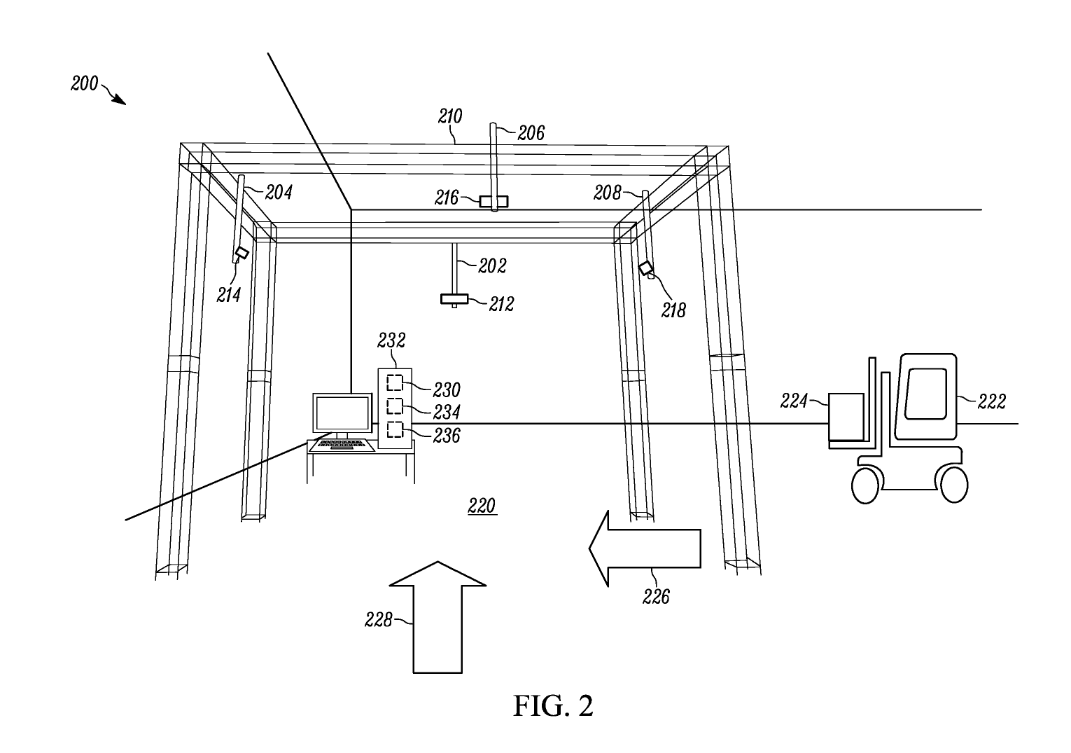

FIG. 2 illustrates an example environment in which example methods, systems and apparatus disclosed herein may be implemented. The example of FIG. 2 is representative of a loading dock including a dimensioning system 200 constructed in accordance with teachings of this disclosure. The example dimensioning system 200 of FIG. 2 is includes a north imaging station 202, a west imaging station 204, a south imaging station 206, and an east imaging station 208. The imaging stations 202-208 of FIG. 2 are mounted to a frame 210. Alternative examples include any suitable number (e.g., three (3) or five (5)) of imaging stations deployed in any suitable manner (e.g., mounted to walls). The terms “north,” “west,” “south” and “east” are used for ease of reference and not limitation. Each of the imaging stations 202-208 of FIG. 2 includes an image capture device (termed an image sensor) 212-218, respectively, capable of capturing color data and depth data in a respective coordinate system. For example, each of the image sensors 212-218 is an RGB-D sensor that generates an RGB value and a depth value for each pixel in a coordinate system. In alternative examples, each of the imaging stations 202-208 includes a three-dimensional (3D) image sensor that provides depth data and a separate two-dimensional (2D) image sensor that provides color data. In such instances, the 2D image sensor is registered to the coordinate system of the partner 3D image sensor, or vice versa, such that the color data of each pixel is associated with the depth data of that pixel. While the image sensors 212-218 are described in examples as RGB-D sensors, the techniques herein may be implemented with any type of image sensor, whether still image camera or video capture device, whether 2D devices or a 3D devices.

Each of the image sensors 212-218 of FIG. 2 are pointed toward an imaging area 220. Each of the image sensors 212-218 is tilted (e.g., at a forty-five (45) degree angle toward a floor of the imaging area 220. As such, each of the image sensors 212-218 generate color data and depth data representative of the imaging area 220. When a vehicle 222 carrying an object 224 enters the imaging area 220, the image sensors 212-218 generate image data, such as color data and depth data, representative of the vehicle 222 and the object 224 from their respective perspectives.

In the example of FIG. 2, the vehicle 222 is a forklift and the object 224 is a package to be dimensioned by the dimensioned system 200. For example, the vehicle 222 may be in the process of moving the object 224 from a warehouse location to a trailer or other type of container associated with the loading dock illustrated in FIG. 2. In the illustrated example, vehicles can enter the imaging area 220 in a first direction 226 or a second direction 228. However, any suitable number of directions are possible depending on, for example, surrounding environmental arrangement of the loading dock. As illustrated in FIG. 2, the vehicle 222 is entering the imaging area 220 in the first direction 226, which is towards the west imaging station 214.

To efficiently and accurately dimension the object 224 being carried by the vehicle 222 without interrupting movement of the vehicle 222 and without requiring removal of the object 224 from the vehicle 222, the example dimensioning system of FIG. 2 includes a freight dimensioner 230. The example freight dimensioner 230 of FIG. 2 is an application that receives frames of image data from the images sensors 212-218 and analyses the frames to determine, for example, one or more dimensions of an object appearing in the frames. In the illustrated example of FIG. 2, the freight dimensioner 230 is implemented on a processing platform 232 deployed at the loading dock. However, the example freight dimensioner 30 disclosed herein may be implemented in any suitable processing platform such as, for example, a processing platform deployed on the vehicle 222 and/or a mobile processing platform carried by a person associated with the vehicle 222 or, more generally, the loading dock. The freight dimensioner 230 of FIG. 2 is an example of a target application that receives frames of image data from the image sensors 212-218. The processing platform 232 may include any number of other target applications that receive image data frames for other processing, those applications represented by target application 234.

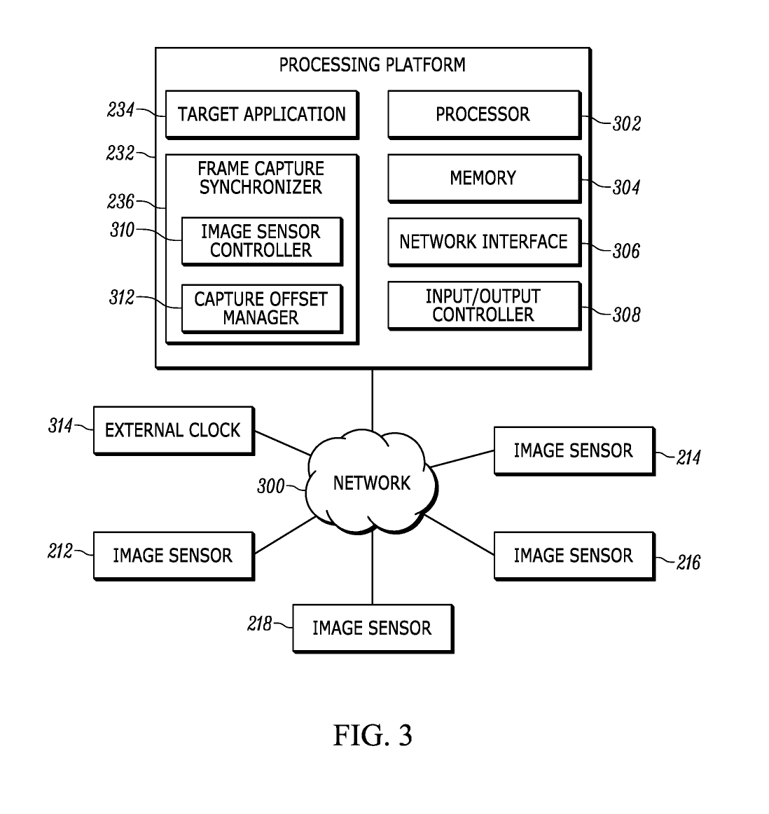

In the example of FIG. 2, a frame capture synchronizer 236 constructed with teachings of this disclosure is implemented on the processing platform 232. Like the freight dimensioner 230 and, more generally, the target application 234, the example frame synchronizer 236 of FIG. 1 may be implemented in any suitable processing platform such as, for example, a processing platform deployed on the vehicle 222 and/or a mobile processing platform carried by a person associated with the vehicle 222 or, more generally, the loading dock. As described in detail below, the example frame synchronizer 236 controls data capture operations of the image sensors 212-218 such that frames of image data provided to the target application 234 truly correspond to the same time and, thus, can be merged together to obtain an accurate representation of the imaging area 220 from all of the different perspectives provided by the differently positioned image sensors 212-218. An example implementation of the frame capture synchronizer 236 of FIG. 2 is described below in connection with FIG. 3.

While the following description is presented in the context of package loading and delivery, similar challenges exist in other environments and applications that involve a need for accurate and efficient dimensions of objects. For example, inventory stocking operations and warehouse management operations suffer when objects are not accurately placed in assigned locations. Further, while example methods, systems and apparatus disclosed herein are described below in connection with package loading operations at a loading dock, example methods, systems and apparatus disclosed herein can be implemented in any other suitable context or environment such as, for example, a warehouse, a retail establishment, an airport, a train loading location, or a shipping port.

FIG. 3 is a block diagram illustrating an example implementation of the frame capture synchronizer 236 of FIG. 2 executed on the example processing platform 232 of FIG. 2. In the example of FIG. 3, the processing platform 232 and, thus, the frame capture synchronizer 236, is in communication with the image sensors 212-218 through a network 300. The network 300 may be a wired or wireless network. Alternatively, the image sensors 212-218 may be in direct communication with the processing platform 232. During imaging of the object 224, the image sensors 212-218 collect and transmit image data to the processing platform 232. The processing platform 232 is implemented as, for example, a logic circuit capable of executing instructions to, for example, implement the example operations represented by the flowcharts of the drawings accompanying this description. As described below, alternative example logic circuits include hardware (e.g., a gate array) specifically configured for performing operations represented by the flowcharts of the drawings accompanying this description.

The example processing platform 232 includes a processor 302 such as, for example, one or more microprocessors, controllers, and/or any suitable type of processor. The example processing platform 332 includes memory (e.g., volatile memory, non-volatile memory) 304 accessible by the processor 302 (e.g., via a memory controller). The memory 304 may represent one or more processors. The example processor 302 interacts with the memory 304 to obtain, for example, machine-readable instructions stored in the memory 304 corresponding to, for example, the operations represented by the flowcharts of this disclosure and other processes described herein. Additionally or alternatively, machine-readable instructions corresponding to the example operations of the flowcharts may be stored on one or more removable media (e.g., a compact disc, a digital versatile disc, removable flash memory, etc.) that may be coupled to the processing platform 232 to provide access to the machine-readable instructions stored thereon.

The example processing platform 232 includes a network interface 306 to communicate with the image stations 202-208, and more specifically to capture image data from the respective image sensors 212-218. In some examples, the network interface 306 may communicate with other machines via the network 300. The example network interface 306 includes any suitable type of communication interface(s) (e.g., wired and/or wireless interfaces) configured to operate in accordance with any suitable protocol(s).

The example processing platform 232 of FIG. 2 includes input/output (I/O) interfaces 308 to enable receipt of user input and communication of output data to the user.

In the example of FIG. 3, the processing control platform 232 includes the target application 234 (which, as described above, may be a dimensioning application and/or any other type of application that uses image data generated by the image sensors 212-218) and the frame capture synchronizer 236. The example frame capture synchronizer 236 includes an image sensor controller 310 to control initialization and restarting of the imaging sensors 212-218. The processing platform 232 further includes a capture offset manager 312 that determines capture offsets for each of the image sensors 212-218. Additionally, the capture offset manager 312 of FIG. 3 maintains an offset threshold value which, as described below, is compared to the capture offsets of the image sensors 212-218.

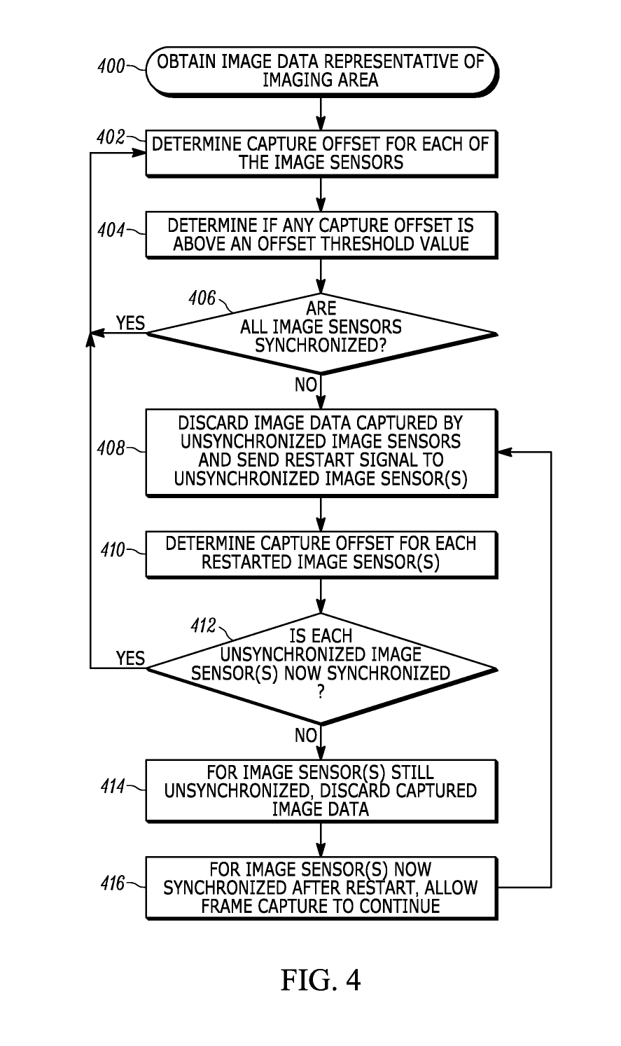

FIG. 4 is flowchart representative of example operations capable of implementing the example frame capture synchronizer 236 of FIGS. 2 and/or 3. As described above in connection with FIG. 2, the image sensors 212-218 of the dimensioning system 200 generate three-dimensional image data (e.g., an RGB-D value for each of a plurality of pixels) representative of the imaging area 220 from different perspectives. In the example process of FIG. 4, the frame capture synchronizer 236 receives frames of image data from one or more of the image sensors 212-218, at block 400. The received image data is stored in the memory 304, for example.

If during initialization of the dimensioning system 200, the latency associated with starting an image sensor device were highly predictable, then the initialization process could start to at a specific time relative to a system clock. However, typically random latencies associated with starting an image sensor device making predicting capture offset among the image sensors 212-218 impracticable, if not impossible. With the present techniques, however, the initialization process may be started at any time, without any special timing consideration (e.g., coordination of the respective startup procedures of the different image sensors 212-218). As such, the example process of FIG. 4 may start before startup of the image sensors 212-218 or after startup of all or some portion of the image sensors 212-218. Indeed, the example process of FIG. 4, once started, may run continuously, so that upon the addition of new image sensors to the dimensioning system 200, the processing platform 232 can ensure that frame capture of the new image sensors is synchronized with the existing image sensors 212-218.

The example processing platform 232 of FIG. 3 receives the captured frames of image data and supplies the frames to the capture offset manager 312. In the example of FIG. 4, the capture offset manager 312 determines a capture offset for each of the image sensors 212-218 (block 402). Additionally, the example capture offset manager 312 determines if any capture offset of any of the image sensors 212-218 is above an offset threshold value. The offset threshold value may be stored in the memory 304, for example. In some examples, the offset threshold value is determined as follows. The frame rate is typically an integer number of frames per second, such as thirty (30) frames per second. At thirty (30) frames per second, the implied period for frame capture at the image sensors 212-218 is a period (T) of 1/30, or roughly 33 ms. Therefore, the capture offset manager 312 may be configured to set the offset threshold value at 33 ms. That is, the offset threshold value is calculated based on the frame capture rate of the image sensors 212-218. In some examples, the capture offset manager 312 is configured to detect the frame capture rate of the image sensors 212-218 and to calculate the offset threshold value using the frame rate of the image sensors 212-218 as an input. Additionally or alternatively, the offset threshold value is entered by, for example, a programmer or administrator of the dimensioning system 200.

The capture offset manager 312 determines the frame capture offset of the image sensors relative to a common time base, which serves as a reference time for the frame capture synchronizer 236. In some examples, the capture offset manager 312 determines the common time base from an external clock in communication with the processing platform 232, such as the clock source 314 shown in FIG. 3. For example, the clock source 314 may be a global positioning system (GPS) based clock source. In some examples, the capture offset manager 312 determines the common time base from an external dedicated clock signal received over the network 300, from any suitable source. In some examples, the capture offset manager 312 determines the common time base from the frame rate of one of the plurality of fixed-frame rate image sensors 212-218. For example, the offset capture manager 312 may identify the first image sensor sending image data and establish a common time base associated by starting (or resetting) an internal clock upon receipt of the image data.

The offset capture manager 312 will have a continuously running clock, or access such a clock for the processing platform 232. That clock may have a zero/starting time based on the common time base. The offset capture manager 312 may store a frame rate period representing the timing between image frames as captured at the image sensor. In the example of FIG. 1, the frame rate period is 33 ms. To determine an offset for an image sensor, upon receipt of an image frame from an image sensor, the offset capture manager 312 determines a timestamp for the time the image frame was received, and then the capture manage 312 may perform a modulo function on the timestamp, comparing the timestamp to the nearest frame rate period, e.g., 33 ms. The resulting output from the modulo function represents the offset for the received image frame. The offset capture manager 312 may do this for one image frame, for each image frame, for periodic image frames, for random numbered image frames, or for some set of images frames, from which an average offset may be determined.

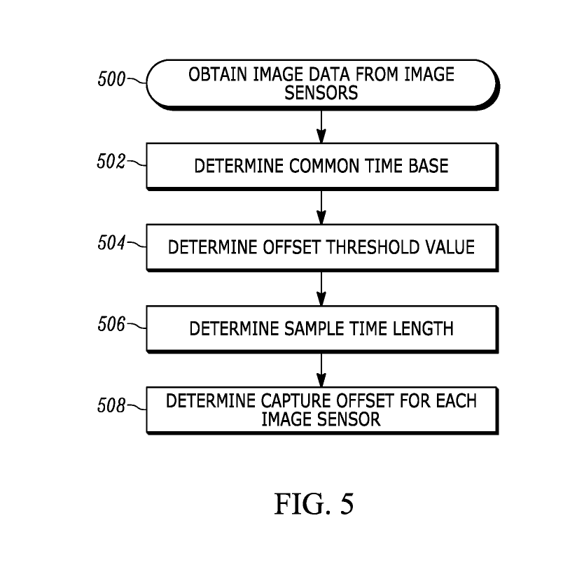

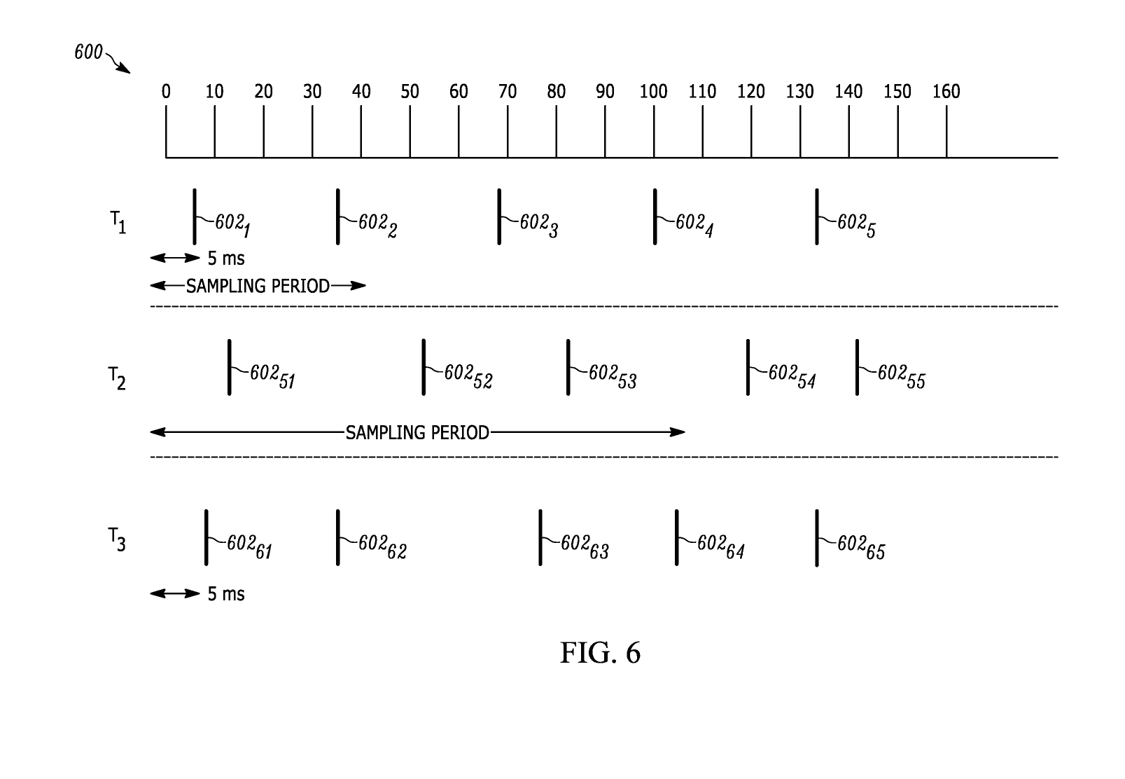

After determining a capture offset for each of the image sensors 212-218, the capture offset manager 312 determines if any of the capture offsets are greater than the offset threshold value (block 404). An image sensor that has a capture offset greater than the offset threshold value is determined to have a failed offset. In other words, the image sensor is considered unsynchronized. In such cases, the timing of the images received at the processing platform 232 lacks sufficient synchronization such that the target application 234 may not properly identify and analyze the captured images from unsynchronized image sensors. Example implementations of the determinations of blocks 402 404 are provided below in reference to FIGS. 5-6.

If all of the image sensors 212-218 are determined to be synchronized according to the comparison of the respective capture offsets to the common base time (block 406), the process returns to block 402. If one or more of the image sensors 212-218 are determined to be unsynchronized (i.e., image sensor(s) are determined to have an offset above the offset threshold value, image data obtained from the unsynchronized image sensor(s) is discarded for the offending time period and the image sensor controller 310 sends a restart signal to the each unsynchronized image sensor (block 408). Discarding the image data includes, for example, not authorizing use of the image data by the target application 234. In the illustrated example, the restart signal instructs the receiving image sensor to cycle OFF, thereby stopping image data capture, and then cycle ON, to restart capturing image data.

In examples where the process is to run continuously, control is returned to block 402 where the process starts again. In other examples, the process operates according to a schedule, in which case a determination is made by the frame capture synchronizer 236 when to re-initiate control at block 402.

After the unsynchronized image sensor(s) have restarted, the example capture offset manager 312 determines the capture offset for each of the restarted image sensor(s) (block 410). In some examples, the capture offset manager 312 will wait for a restart period before receiving subsequent image data from the restarted image sensor. That restart period may be pre-stored at the processing platform 232. Whether pre-stored or determined by the capture offset manager 312, the restart period is a time value long enough to allow the image sensor to go through a power up cycle and start capture new image frames.

Alternatively, the capture offset manager 312 may determine the capture offset for all of the image sensors 212-218 after one or more of the image sensors 212-218 were restarted. That is, the example process of FIG. 3 could alternatively proceed from block 408 to block 402. In the illustrated example, if each unsynchronized, restarted image sensor is now synchronized according to a comparison between the respective capture offset and the common base time (block 412), control returns to block 402 and image data is no longer discarded for any of the image sensors 212-218. For example, at the block 412, the capture offset manager 312 may apply a second threshold offset for determining if the restarted image sensor is synchronized or not. That is, in some examples, a first threshold offset may be used to determine if an active image sensor is (un)synchronized and a second threshold offset may be used to determine if a restarted image sensor is (un)synchronized. The two threshold offsets may be the same. In some examples, the second threshold offset may be a smaller value than the first threshold offset.

If one or more of the unsynchronized, restarted image sensor(s) are still unsynchronized (block 412), any image data received from those image sensor(s) is discarded (block 414). For any of the restarted image sensor(s) that is now considered synchronized according to the comparison of the respective capture offset and the common base time, the corresponding image data is no longer discarded (e.g., the image data is authorized for use by the target application 234) (block 416). The example process of FIG. 4 then proceeds to block 408. As with the block 410, the capture offset manager 312 may wait a restart period before collecting new image frames from restarted image sensor. Waiting the restart period may allow the processing platform 232 to temporarily direct processing resources to other image processing demands.

FIG. 5 is flowchart representative of an example process that may be executed by the capture offset manager 312 to implement block 402 of FIG. 4. The image data from the image sensors is obtained (block 500) from block 400. The capture offset manager 312 determines or obtains a common time base from, for example, the external clock source 314, as described herein, or an internal clock of the processing platform 232 (block 502). The common time base is maintained for the frame capture synchronizer 236 independent from the image sensors 212-218, in that the internal clocks of the image sensors 212-218 are not synchronized with the common time base utilized by the frame capture synchronizer 236. This independence allows the capture offset manager 312 to independently assess each image sensor 212-218 to independently assess whether any one of the image sensors 212-218 is not properly synchronized with the image data received from the other image sensors 212-218. The independence of the common time base is maintained whether the common time base is determined from an external system clock source, from an external dedicated clock signal, from the frame rate or clock of one of the image sensors, etc.

The capture offset manager 312 determines a capture offset threshold value (also termed a synchronization limit) for the system (block 506), where the capture offset threshold value may be determined a number of different ways, as now discussed (block 504).

The capture offset manager 312 may determine the offset threshold value for each received image frame, from the timing period, which is 33 ms in the illustrated example. Each fixed-frame rate imaging sensor uses a 33 ms capture rate and the capture offset manager 312 may set the threshold capture offset below that time period (block 506). In some examples, the offset threshold capture value is already predetermined and stored in the memory 304 (block 506). In such examples, the offset threshold value may be predetermined for different types of image sensor. For example, a 2D camera with a 30 fps may have pre-set, stored a offset threshold value of 5 ms, while a 3D camera having a 30 fps may have a offset threshold value of 10 ms or 15 ms. The sample time length (also termed a sampling period) may be the inverse of the frame rate per second, i.e., 33 ms for a 30 fps image sensor. As described, where averaging image frame offsets over the sample time length, that average can thus be analyzed to determine if it is greater than an inverse of the frame rate, i.e., when the sample time length is set at the inverse of the frame rate. In some embodiments, the sample time length will be less than the inverse of the frame rate per second. The threshold capture offset may be determined through additional statistical analyses such as using standard deviation. For example, threshold capture offset may be determined to maintain a specified number of cameras within a standard deviation of offset. Cameras outside of that standard deviation may be identified as being above a threshold capture offset and thereby requiring synchronization. In other examples, a predetermined minimum number of samples required to get a sufficiently confident standard deviation may be used to determine a sample length of time. For this example, the sample length of time may equal the frame time (33 ms) times the minimum number of samples.

The capture offset manager 312 may determine two different offset threshold values, a first threshold that is used to determine when an image sensor capture offset has failed, and a second threshold used to determine when a failed offset image sensor has been resynchronized to a sufficient capture offset level. By having two different thresholds, the offset manger 312 may provide additional control over when to synchronize cameras and the amount of synchronization. In some examples, the first threshold is the same as the second threshold.

At block 508, the capture offset manager 312 determines the sample length, which is the number of image frames that will be collected for determining the capture offset for an image sensor. That sample length may be universal and applied to each of the image sensors 212-218, as described in the example herein, or that sample length may be dynamic and vary from image sensor to image sensor.

In the illustrated example, the capture offset manager 312 may continuously analyze obtained image data and determine the amount of timing variances across the imaging sensors 212-218 and the range of those timing variances. That analysis gives an indication of the amount of jitter in the system overall. If the timing variance range is relatively small, e.g., falling within an acceptable jitter range, then the capture offset manager 312 will set the sample length to be small. The capture offset manager 312, for example, could be configured to assign a sample length of 1 image data frame (i.e., 33 ms) when the timing variance range is 5 ms. In the illustrated example, the timing variance range is 10 ms (obtained by subtracting the smallest timing variance (6 ms) from the largest timing variance (16 ms)) over the collected image frames. In the illustrated example, the capture offset manager 312 may be configured to set the sample length at 5 image data frames (5×33 ms=165 ms). The capture offset manager 312 may access a lookup table of timing variance ranges and corresponding sample times, for example.

With the offset threshold value (block 504) and the sampling length (block 506) determined, the capture offset manager 312 then determines the capture offset for each image sensor (block 508). The capture offset is determined against the common time base and is determined over the sampling length.

FIG. 6 illustrates an example timing diagram 600 for one image sensor under continuous analysis under the example process, with continuous determination of the capture offset over time. Over a first time slot, T₁, a modulo function is applied to the first received image data frame 602₁ (from 602₁ to 602₅), which identifies the offset as 5 ms from the common time base 604 (the initial image data frame 602₁ is received at 5 ms after the 0 time of the common time base). In the illustrated example, time slot T₁ shows little latency or jitter variation for each subsequent frame, such that each of image data frame 602₁-602₅ is 5 ms offset from the common time base, using the modulo: Time_Received mod Image_Sensor_Frame_Rate_Period (e.g., Time_Received mod 33). Note that using the modulo operation allows the time of the receipt of the image data frame to be assessed against the next applicable time period, e.g., the corresponding, preceding period value on the timeline. The modulo operation returns a positive value for the capture offset, regardless of whether the corresponding image data frame precedes or lags to corresponding nearest sampling period value. In the illustrated example, for this first time period, T₁, the capture offset manager 312 determined (at block 506) that that a single frame sampling time length was sufficient to assess capture offset. In this example, the modulo function is used and only for one frame.

During continual assessment of the image sensor, however, latency and jitter effects will alter the capture offset of image data obtained from the image sensor. At a second time period, T₂, the image data frames 60251-60255 have capture offsets that differ from the constant 5 ms of T₁, and the capture offsets are no longer the same for each image data frame. For the time period T₂, the sampling time (block 506) had been determined to be 3 frames (i.e., approx. 100 ms). As a result of the capture offset manager 312 determines an average of the capture offsets over the sampling time, averaging 15 ms (33 ms-18 ms), 14 ms (52 ms-66 ms), and 16 ms (99 ms-83 ms), resulting in approx. 15 ms average capture offset over the sampling period. For greater length sampling periods, the capture offset manager 212 will average over a larger number of image data frames.

Once the capture offset is determined over the sampling period, the capture offset manager 312 then compares the capture offset for the image sensor to offset threshold value at block 404. When the capture offset is greater than the offset threshold value (e.g., applying a threshold offset of 10 ms, for the time period T₂ the image sensor is determined to have a failed capture offset) then the capture offset manager 312 instructs the image sensor controller 210 to send a restart signal to the offending image sensor and to wait a restart period (block 408). The restart signal may be communicated over the network 300 and may be power interrupt signal that cycles the power of the image sensor completely, a hardware reset signal that cycles internal hardware of the image sensor to restart while power is maintained, or a software reset that instructs the image sensor to start capturing image data at a new starting time.

As the example process of FIG. 4 continues, image data from the restarted image sensor is obtained and analyzed as discussed above. The time period, T₃, in FIG. 6 illustrates the image data frame capture sequence after the restart, showing that for this particular restart the capture offset has been determined to be 8 ms (602₆₁-602₆₅), which is within the offset threshold value.

The processing platform 232 may be configured such that upon restarting an image sensor, the most recently determined sampling period for that image sensor (block 506) may be used after restart. In other examples, the processing platform 232 may be configured to reset the sampling period.

While the foregoing example was described applying a modulo (MOD) function, other functions may be used instead, such as a remainder (REM) function or a bit (right) shift operation.

In FIG. 4, at block 404 the capture offset is compared to the offset threshold value to determine if the value of the former is larger than the value of the latter. In some examples, the capture offset manager 312 monitors for image sensor drift by storing capture offset values over time and examining stored values for increases in capture offset. As capture offset values increase, the capture offset manager 212 determines how long it takes for the particular image sensor to reach failed offset, e.g., minutes, hours, or days. Such information may be used by the capture offset manager 312 to initiate a restart signal before the comparison at block 404. In some examples, such information may be used to identify an image sensor that requires restart too often, which may indicate a faulty image sensor. The capture offset manager 312 may be configured to display an electronic indication (e.g., alarm) to personnel for such faulty image sensors on, for example, a display monitor associated with the processing platform 232.

In some examples, image sensors may be configured with an adjustable internal clock, such that upon receipt of a restart signal, the clock of the image sensor is adjusted, e.g., restarted, as well. In some examples, image sensors may be configured with phase adjustable clock circuit that allows for small adjustments to the internal clock of the image sensor to allow for more dynamic changes in response to a restart signal.

The time synchronization techniques described herein may be used to correct for time jitter from a camera system. The synchronization may be used in some examples to establish simultaneous or near simultaneous image capture from a plurality of camera stations. The synchronization may also be used to maintain highly accurate time measures of when an image is captured by various camera stations. For example, the synchronization techniques may be used to identify and/or maintain an accurate, and intended, image capture time difference between camera stations. For example, if a target is mobile and one knows the velocity of a vehicle carrying the target or of the target itself, it may be desirable to maintain time differences between when different camera stations fire and capture an image. In such examples, synchronization may be used to maintain time differences of the captured images based on the velocity of the target. The time differences between camera stations, multiplied by the velocity of a mobile target, gives an indication of a spatial correction that can be used to combine images from different camera stations into a common location in space.

The above description refers to block diagrams of the accompanying drawings. Alternative implementations of the examples represented by the block diagrams include one or more additional or alternative elements, processes and/or devices. Additionally or alternatively, one or more of the example blocks of the diagrams may be combined, divided, re-arranged or omitted. Components represented by the blocks of the diagrams are implemented by hardware, software, firmware, and/or any combination of hardware, software and/or firmware. In some examples, at least one of the components represented by the blocks is implemented by a logic circuit. As used herein, the term “logic circuit” is expressly defined as a physical device including at least one hardware component configured (e.g., via operation in accordance with a predetermined configuration and/or via execution of stored machine-readable instructions) to control one or more machines and/or perform operations of one or more machines. Examples of a logic circuit include one or more processors, one or more coprocessors, one or more microprocessors, one or more controllers, one or more digital signal processors (DSPs), one or more application specific integrated circuits (ASICs), one or more field programmable gate arrays (FPGAs), one or more microcontroller units (MCUs), one or more hardware accelerators, one or more special-purpose computer chips, and one or more system-on-a-chip (SoC) devices. Some example logic circuits, such as ASICs or FPGAs, are specifically configured hardware for performing operations (e.g., one or more of the operations represented by the flowcharts of this disclosure). Some example logic circuits are hardware that executes machine-readable instructions to perform operations (e.g., one or more of the operations represented by the flowcharts of this disclosure). Some example logic circuits include a combination of specifically configured hardware and hardware that executes machine-readable instructions.

The above description refers to flowcharts of the accompanying drawings. The flowcharts are representative of example methods disclosed herein. In some examples, the methods represented by the flowcharts implement the apparatus represented by the block diagrams. Alternative implementations of example methods disclosed herein may include additional or alternative operations. Further, operations of alternative implementations of the methods disclosed herein may combined, divided, re-arranged or omitted. In some examples, the operations represented by the flowcharts are implemented by machine-readable instructions (e.g., software and/or firmware) stored on a medium (e.g., a tangible machine-readable medium) for execution by one or more logic circuits (e.g., processor(s)). In some examples, the operations represented by the flowcharts are implemented by one or more configurations of one or more specifically designed logic circuits (e.g., ASIC(s)). In some examples the operations of the flowcharts are implemented by a combination of specifically designed logic circuit(s) and machine-readable instructions stored on a medium (e.g., a tangible machine-readable medium) for execution by logic circuit(s).

As used herein, each of the terms “tangible machine-readable medium,” “non-transitory machine-readable medium” and “machine-readable storage device” is expressly defined as a storage medium (e.g., a platter of a hard disk drive, a digital versatile disc, a compact disc, flash memory, read-only memory, random-access memory, etc.) on which machine-readable instructions (e.g., program code in the form of, for example, software and/or firmware) can be stored. Further, as used herein, each of the terms “tangible machine-readable medium,” “non-transitory machine-readable medium” and “machine-readable storage device” is expressly defined to exclude propagating signals. That is, as used in any claim of this patent, none of the terms “tangible machine-readable medium,” “non-transitory machine-readable medium,” and “machine-readable storage device” can be read to be implemented by a propagating signal.

As used herein, each of the terms “tangible machine-readable medium,” “non-transitory machine-readable medium” and “machine-readable storage device” is expressly defined as a storage medium on which machine-readable instructions are stored for any suitable duration of time (e.g., permanently, for an extended period of time (e.g., while a program associated with the machine-readable instructions is executing), and/or a short period of time (e.g., while the machine-readable instructions are cached and/or during a buffering process)).

Although certain example apparatus, methods, and articles of manufacture have been disclosed herein, the scope of coverage of this patent is not limited thereto. On the contrary, this patent covers all apparatus, methods, and articles of manufacture fairly falling within the scope of the claims of this patent.

What is claimed:

1. A method of synchronizing image frame capture timing for a plurality of fixed-frame rate image sensors having a same frame rate, the method comprising:
determining, at a logic circuit, a capture offset for each of the plurality of fixed-frame rate image sensors, the capture offset being based on a common time base that is independent from the plurality of fixed-frame rate image sensors;
when the capture offset for a first one of the image sensors is greater than a first threshold value, sending, from the logic circuit, a restart signal to the first one of the image sensors to restart the first one of the image sensors and awaiting a restart period before receiving subsequent image data from the first one of the image sensors; and
when the capture offset for the first one of the image sensors is less than a second threshold offset value, determining that the first one of the image sensors is synchronized to the common time base and continuing to receive subsequent image data from the first one of the image sensors.

2. The method of claim 1, further comprising:
receiving, at the logic circuit, the common time base from an external system clock source.

3. The method of claim 1, further comprising:
receiving, at the logic circuit, the common time base from an external dedicated clock signal.

4. The method of claim 1, further comprising:
determining, at the logic circuit, the common time base from the frame rate of one of the plurality of fixed-frame rate image sensors.

5. The method of claim 1, wherein the first threshold offset value and the second threshold offset value are the same.

6. The method of claim 1, wherein determining the capture offset for each of the plurality of fixed-frame rate image sensors comprises:
for each image sensor:
identifying, at the logic circuit, image frames over a sampling period;
calculating an image frame offset for each of the image frames compared to the common time base, using a modulo operation; and
averaging the image frame offset over the sampling period greater than an inverse of the frame rate to determine the capture offset for the respective image sensor.

7. The method of claim 6, wherein the sampling period is a same value for each of the image sensors.

8. The method of claim 6, wherein the sampling period is different for at least two of the image sensors.

9. The method of claim 1, wherein sending the restart signal to the first one of the image sensors to restart the first one of the image sensors comprises:
sending a power interrupt signal, a hardware reset signal, or a software reset signal to the first one of the image sensors.

10. A tangible machine-readable medium comprising instructions that, when executed, cause a machine to:
determine a capture offset for each of a plurality of fixed-frame rate image sensors, the capture offset being based on a common time base for a logic circuit communicatively coupled to the plurality of image sensors, where the common time base is independent from the plurality of image sensors;
compare the capture offset for a first one of images sensors to a threshold capture offset;
when the capture offset for the first one of the image sensors is greater than threshold capture offset, send a restart signal to the first one of the image sensors to restart the first one of the image sensors and await a restart period before receiving subsequent image data from the first one of the image sensors; and
when the capture offset for the first one of the image sensors is less than a second threshold capture offset, determine that the first one of the image sensors is synchronized to the common time base and continue to receive subsequent image data from the image sensor.

11. A tangible machine-readable medium as defined in claim 10, wherein the instructions, when executed, cause the machine to:
receive the common time base from an external synchronized system clock source.

12. A tangible machine-readable medium as defined in claim 10, wherein the instructions, when executed, cause the machine to:
receive the common time base from an external dedicated clock signal.

13. A tangible machine-readable medium as defined in claim 10, wherein the instructions, when executed, cause the machine to:
determine the common time base from the frame rate of one of the plurality of fixed-frame rate image sensors.

14. A tangible machine-readable medium as defined in claim 10, wherein the first threshold offset value and the second threshold offset value are the same.

15. A tangible machine-readable medium as defined in claim 10, wherein the instructions, when executed, cause the machine to, for each image sensor,
identify image frames over a sampling period;
calculate an image frame capture offset for each of the image frames compared to the common time base, using a modulo operation; and
average the image frame capture offset over a sampling period greater than an inverse of the frame rate to determine the capture offset for the respective image sensor.

16. A tangible machine-readable medium as defined in claim 15, wherein the sampling period is a same value for each of the image sensors.

17. A tangible machine-readable medium as defined in claim 15, wherein the sampling period is different for at least two of the image sensors.

18. A tangible machine-readable medium as defined in claim 10, wherein the instructions, when executed, cause the machine to:
send a power interrupt signal, a hardware reset signal, or a software reset signal to the first one of the image sensors.

19. An apparatus comprising:
a capture offset manager to:
determine a capture offset for each of a plurality of fixed-frame rate image sensors, the capture offset being based on a common time base for the capture offset manager coupled to the plurality of image sensors, where the common time base is independent from the plurality of image sensors; and
compare the capture offset for a first one of images sensors to a threshold capture offset; and
an image sensor controller to:
when the capture offset manager determines that the capture offset for the first one of the image sensors is greater than threshold capture offset, send a restart signal to the first one of the image sensors to restart the first one of the image sensors and await a restart period before receiving subsequent image data from the first one of the image sensors; and
when the capture offset manager determines that the capture offset for the first one of the image sensors is less than a second threshold capture offset, the capture offset manager determines that the first one of the image sensors is synchronized to the common time base, to continue to receive subsequent image data from the image sensor, wherein at least one of the capture offset manager and the image sensor controller is implemented by a logic circuit.

20. The apparatus of claim 19, wherein the capture offset manager is to:
determine the common time base from the frame rate of one of the plurality of fixed-frame rate image sensors.

21. The apparatus of claim 19, wherein the first threshold offset value and the second threshold offset value are the same.

22. The apparatus of claim 19, wherein the capture offset manager is to:
identify image frames over a sampling period;
calculate an image frame capture offset for each of the image frames compared to the common time base, using a modulo operation; and
average the image frame capture offset over a sampling period greater than an inverse of the frame rate to determine the capture offset for the respective image sensor.

23. The apparatus of claim 24, wherein the sampling period is different for at least two of the image sensors.
